(19) United States
(12) Patent Application Publication
(10) Pub. No.: US 2009/0136884 A1
(43) Pub. Date: May 28, 2009

(54) Direct-Fired Furnace Utilizing An Inert Gas To Protect Products Being Thermally Treated In The Furnace

(76) Inventor: Stewart C. Jepson, Forest Park, IL (US)

Correspondence Address: AIR LIQUIDE;Intellectual Property, 2700 POST OAK BOULEVARD, SUITE 1800, HOUSTON, TX, 77056, US

(21) Appl. No.: 12/332,666

(22) Filed: Dec. 11, 2008

Related U.S. Application Data
(63) Continuation-in-part of application No. 11/532,644, filed on Sep. 18, 2006, now abandoned.

(51) Int. Cl. C21B 9/14; F27D 7/02

(52) U.S. Cl. 432/14; 266/141

(57) ABSTRACT

A heating system includes a furnace configured to receive a product to be thermally treated within the furnace, where the furnace includes at least one burner to generate combustion gases from a source of oxygen and a carbon-based fuel source provided to the burner, and the combustion gases provide heat to the product disposed within the furnace. A gas pipeline delivers a heated inert gas into the furnace at a location proximate the product so as to at least partially surround and protect a surface of the product and minimize or prevent the product from chemically reacting with other gases within the furnace.

### CROSS-REFERENCE TO RELATED APPLICATION

This application is a continuation-in-part of U.S. patent application Ser. No. 11/532,644, filed Sep. 18, 2006, entitled “Direct-Fired Furnace Utilizing an Inert Gas to Protect Products Being Thermally Treated in the Furnace”, the entire contents of which are hereby incorporated by reference.

### BACKGROUND

1. Field

The present disclosure pertains to direct-fired heating and/or melting furnaces, such as aluminum or steel furnaces, and to providing an inert atmosphere within the furnace that minimizes or prevents undesirable reactions from occurring to the heated product.

2. Related Art

In conventional direct-fired (fuel-fired) heating or melting furnaces, the flame and/or products of combustion directly contact the furnace product or load that is heated or melted. Heat is transferred directly, from the flame and/or combustion products, to the load by a combination of radiation and convection. Two exemplary embodiments of direct-fired heating furnaces are steel slab or billet reheat furnaces and aluminum melting furnaces.

Different types of burners are employed to provide varying combinations of radiant and convective heat transfer, depending on the needs of the heating process. In some furnaces, high velocity (e.g., high momentum) burners are aimed directly at the load so that the flame directly impinges on the load to provide a high level of convective heat transfer along with a high degree of furnace gas recirculation. In other furnaces, low velocity or “soft” flames are fired above the load, often proximate or hugging the “ceiling” of the refractory lined furnace, to impart heat transfer to the load primarily by radiation, with little or no direct contact between the flame and the load and very little induced furnace gas recirculation.

With either type of high velocity or low velocity burner being employed in a direct-fired furnace, the load will be in direct contact with the products of combustion from the burners. This can lead to contact and “scrubbing” action (which can be prolonged, vigorous and intense) between the gaseous furnace atmosphere and the load surface. The furnace atmosphere or combustion gases typically include nitrogen (N₂), carbon dioxide (CO₂) and water (H₂O), often with some amount of excess oxygen (O₂). The furnace gases can further include additional gaseous species including, without limitation, carbon monoxide (CO), hydrogen (H₂), NOₓ species (e.g., NO and NO₂) and hydroxyl (OH) species. For example, in a furnace fired with air-natural gas burners, at a 10% excess air level, the furnace atmosphere will contain gaseous species in the amount of about 2% by volume O₂, 72% by volume N₂, 9% by volume CO₂, and 17% by volume H₂O (all values at wet basis). With O₂-assisted combustion, the N₂ concentration will decrease while the CO₂ and H₂O concentrations increase. Depending on the furnace air infiltration level (e.g., adjusting the flue damper of the furnace to control pressure), N₂ and excess O₂ amounts can be higher.

The majority of the furnace atmosphere or combustion gases can react with the load material, with the exception of nitrogen. Nitrogen is an inert gas that will generally exhibit little or no tendency to react with the load material in comparison to oxygen and other combustion gases present in the furnace. Even with a reducing atmosphere (i.e., sub-stoichiometric O₂ combustion, with O₂ being supplied at sufficient levels to provide zero or substantially no excess O₂ in the furnace atmosphere), CO₂ and H₂O and the other species can react with the furnace load.

For example, in aluminum melting furnaces, O₂, H₂O, and CO₂ can react with aluminum to form aluminum oxide or dross. In steel reheat furnaces, these gaseous species can react with iron to form iron oxide or scale, and these gases can further react with carbon in the steel to form CO and/or CO₂ (decarburization).

In aluminum melting, dross formation (i.e., aluminum oxidation) is undesirable in that it reduces aluminum yield or recovery. Depending on the type of charge materials to be melted, approximately 1% to 10% of the aluminum charged can be oxidized. This increases operational costs, due to the loss of the un-recovered aluminum, the labor and time requirements for skimming the dross from the furnace, and also energy losses from the furnace. Further, a dross layer also acts as an insulator at the charge surface, thus reducing the effectiveness of heat transfer from the flame to the aluminum.

In steel reheating, product scaling (i.e., surface iron oxide formation) and decarburization (i.e., reduction in carbon content of steel) can result in undesirable and harmful effects on steel product quality. Typically, much time and attention is devoted toward trying to reduce or minimize scaling and decarburization in steel reheating, and process windows are often adjusted to cope with the levels of scale and decarburization encountered.

Attempts have been made to substantially reduce or eliminate potential reactions between combustion gas components in the furnace atmosphere and a load being heated and/or melted in the furnace by injecting nitrogen within the furnace to be located near the surface of the load. For example, U.S. Pat. No. 4,806,156 describes providing an inert atmosphere over the immediate surface of a metal in a melting furnace by dripping liquefied gas (e.g., argon, nitrogen or CO₂) onto the metal surface. The process described in the '156 patent is most applicable to relatively small electrically heated furnaces, open or closed to the ambient atmosphere (such as an electric induction furnace), since the liquefied gas is effective at displacing a relatively stagnant ambient atmosphere from the surface of the metal load (i.e., where the only atmosphere movement is via free convection).

However, the process described in the '156 patent would not be very effective or efficient in a relatively large direct-fired furnace, because the furnace atmosphere in such an environment is in a forced convection “flow-through” state, continuously generated by the burners and continuously exiting out the flue of the furnace. The amount of inert gas required to maintain an inert atmosphere over the metal surface in this manner would be large and substantially expensive, and it would also be very difficult to inject the gas in a liquid state in such a furnace.

U.S. Pat. No. 5,421,856 describes a process in which one or more gas injectors are installed in the bottom of an aluminum melting furnace. The gas bubbles from the injectors upward through the molten aluminum, and then breaks the surface to escape to the furnace atmosphere. However, the '856 patent is limited to open-top furnaces. Furthermore, the amount of gas that can typically be injected through such injectors as described in the '856 patent and directed upward through a molten metal bath is very small and, while adequate for stirring/rinsing/degassing of the molten metal, is insufficient to provide sufficient inerting or an atmosphere purging effect at the top surface of the metal load to substantially prevent or eliminate undesirable reactions from occurring at this surface. Further, this process requires significant maintenance and installation considerations to prevent the injectors from clogging during system operation.

### SUMMARY

Systems and corresponding methods are described herein that provide an effective inert gas layer at the surface of a metal product or load in a heating and/or melting furnace (e.g., a direct-fired furnace).

As described herein, a heating system comprises a furnace configured to receive a product to be thermally treated within the furnace, where the furnace includes at least one burner to generate combustion gases from a source of oxygen and a carbon-based fuel source provided to the burner, and the combustion gases provide heat to the product disposed within the furnace. A gas pipeline delivers a heated inert gas into the furnace at a location proximate the product so as to at least partially surround and protect a surface of the product and minimize or prevent the product from chemically reacting with other gases within the furnace.

A method of protecting a product being heated within a furnace is also provided herein. The method comprises providing a source of oxygen and a carbon-based fuel source to at least one burner of the furnace to generate combustion gases, delivering the combustion gases within the furnace to heat the product disposed within the furnace, and delivering a heated inert gas, via a gas pipeline, into the furnace at a location proximate the product so as to at least partially surround and protect a surface of the product and minimize or prevent the product from chemically reacting with other gases within the furnace.

The systems and methods described herein provide an environment or layer of inerting gas in immediate contact with the surface of the metal load, at least partially surrounding the surface of the load so as to prevent or substantially minimize undesirable reactions of the metal with reactive combustion gases in the furnace. In addition, the inerting gas is provided at the surface of the load at a heated temperature so as to reduce or substantially minimize any thermal losses or reduction in thermal efficiency of the furnace in heating the metal load. In an exemplary embodiment, N₂ gas can be injected at the metal surface through a manifold or network of injection ports or nozzles located proximate the product surface, where the N₂ concentration can be maintained at least about 80% by volume, preferably substantially or nearly at 100% by volume, at the metal surface so as to eliminate or significantly reduce the potential for undesirable and detrimental reactions between the heated metal product and the furnace atmosphere.

The above and still further objects, features and advantages of the systems and methods described herein will become apparent upon consideration of the following detailed description of specific embodiments thereof, particularly when taken in conjunction with the accompanying drawings, wherein like reference numerals designate like components.

### BRIEF DESCRIPTION OF THE DRAWINGS

FIG. 1 depicts a schematic and cross-sectional view of an exemplary embodiment of a direct-fired furnace with a heated load of metal and a supply of heated nitrogen from a manifold or grid/network of injection ports that forms a gaseous inert layer at the load surface.

FIG. 2 depicts a schematic and cross-sectional view of an exemplary embodiment of a reverberatory aluminum melting furnace with a heated load of metal and a supply of heated nitrogen from a manifold or grid/network of injection ports that forms a gaseous inert layer at the load surface.

FIG. 3 depicts a schematic top view in plan and partial section of an exemplary embodiment of a walking beam steel billet reheat furnace with a heated load of metal and a supply of heated nitrogen provided from a manifold or grid/network of injection ports that forms a gaseous inert layer at the load surface, where the injection ports are disposed at locations below the billet walking mechanism within the furnace.

FIG. 4 depicts a schematic side view in elevation of a portion of the furnace of FIG. 3, including a portion of the network of injection ports for providing heated nitrogen into the furnace.

### DESCRIPTION OF PREFERRED EMBODIMENTS

The systems and methods described herein substantially minimize or prevent reaction of a furnace product or load (e.g., steel or aluminum) in a direct-fired heating and/or melting furnace with the furnace atmosphere or combustion gases. An inert gas is injected near the load surface (e.g., using a manifold, grid or network of injection ports) so as to at least partially surround a surface of the product, forming an inerting layer that protects the load surface from other gases within the furnace that might otherwise react with the load. In particular, the injected inert gas moves or “pushes” other atmospheric gases within the furnace away from the surface of the load, while maintaining a local atmosphere in the immediate vicinity of the load surface that is substantially entirely composed of the inert gas.

The inert gas is heated prior to injection toward the load surface, preferably using combustion gases within the furnace. In a most preferred embodiment, the inert gas is heated by providing an inlet flow of inert gas through the flue exhaust duct or chamber (i.e., at the exit duct for combustion gases from the furnace) in a counter-current heat exchanger configuration as described below. Providing heated inert gas in this manner facilitates the injection of the gas at the load surface at a temperature that is the same or substantially similar to the furnace process temperature (e.g., at temperature ranges of about 1500° F. (about 815° C.) or greater). Thus, the load surface is not cooled by the injected inert gas, and it is also possible for the inert gas to provide additional load heating by convection, depending on the exact design of the inert gas injection system.

The inert gas injection pipes and heat exchanger of the system can be designed in a practical, cost-efficient manner so as not to mechanically interfere with furnace operation. The inert gas discharge velocity and configuration can further be designed to achieve the desired flow characteristics for the inert gas within the furnace. For example, low velocity injection of the inert gas can be achieved in certain applications to minimize entrainment and mixing with furnace gases. Low velocity injection of the inert gas is preferred for furnaces utilizing low velocity burners (i.e., where the combustion flame and gases are directed close to the furnace ceiling and not directly toward the load to facilitate primarily radiant heating of the load). Alternatively, higher velocity injection of the inert gas can be provided in certain applications (e.g., in furnaces utilizing high velocity burners that direct the flames and combustion gases directly toward the load within the furnace), where the higher velocity inert gases also provide convective heat transfer to the load surface.

Since the inert gas is heated prior to being injected into the furnace atmosphere, the inert gas expands significantly to cover a larger volume when injected toward the load surface. Thus, the inert gas is distributed over a broader surface area to ensure an inerting atmosphere is established and maintained adjacent and/or proximate the load surface throughout operation of the furnace.

Any suitable gas that is inert or basically non-reactive with the load surface can be utilized in the systems and methods described herein. A preferred inert gas for use in the systems and methods is nitrogen. Compared to a typical air-fuel fired furnace, where the average N₂ concentration is about 72% by volume (wet basis), the systems and methods described herein can be configured to provide a nitrogen injection that increases the local N₂ concentration to 80-100% by volume in the furnace atmosphere immediately proximate the load surface, with a significant decrease or elimination of the local concentrations of other gas species at the load surface. This substantially reduces or eliminates the potential for undesirable reactions from occurring at the load surface. For example, utilizing a fuel-fired aluminum melting furnace with a nitrogen injection system of the type described herein will lower process costs by reducing dross formation (thus increasing aluminum yield or recovery), while using the nitrogen injection system as described herein in combination with a fuel-fired steel reheating furnace will improve product quality and simplify process operation by reducing surface scaling (oxidation) and steel decarburization.

Depending upon the heat exchange design and temperature of the heated nitrogen injected at the surface of the load within the furnace, the overall thermal efficiency of the furnace with respect to heat transfer to the load may be slightly reduced. However, depending on the furnace pressure balance, the heated nitrogen (and/or other inert) gas can displace infiltrating air (e.g., ambient air entering through cracks or other partially open sections of the furnace) from the load surface, thus resulting in little or no net thermal penalty being realized from the nitrogen gas injection. By balancing the additional N₂ injection in the furnace with O₂ enrichment of the burner flame (i.e., by enriching the air to the burner with a supply of O₂, thus reducing the concentration of N₂ supplied to the burner), the overall thermal efficiency of the furnace can be maintained or even improved.

In embodiments in which nitrogen is utilized as the inert gas to be provided to the furnace, an air separation plant (ASU) can be utilized to provide substantially all of the required amounts of both O₂ for combustion and N₂ as the inert gas to the furnace. The ASU can have any conventional or other suitable design, where the ASU is suitably configured to receive ambient air through an intake location of the ASU and to generate and output substantially pure streams of O₂ and N₂ at the required flow rates and amounts for use with the furnace during operation.

Thus, the burner(s) can be enriched with O₂ from the ASU by substantially the same amount or stoichiometric ratio as the amount of N₂ supplied from the ASU to the furnace for use as the inerting gas at the load surface. This facilitates or even enhances the same overall (global) thermal efficiency in comparison to a furnace system using air with no N₂ gas inerting. To achieve the same or substantially similar total BTU input rating and total combustion oxygen supply for a conventional furnace, the pure O₂ requirement needed to correspond with the N₂ injection rate for inerting at the load surface can easily be provided from the ASU. In particular, the overall thermal balance can be maintained by re-distributing some (or all) of the N₂ and O₂ in the original combustion air requirement, as pure O₂ for combustion and pure N₂ for local load surface inerting. The O₂ and N₂ required can further be provided (or substantially provided) by a single common air separation plant.

The systems and methods described below can include any one or more suitable controllers and/or sensors to facilitate monitoring and control of various operational parameters during heating of the load in the furnace. In particular, any suitable number of temperature sensors (e.g., thermocouples) can be provided at one or more locations within the N₂ distribution lines and/or at suitable locations of the furnace to monitor the temperature of nitrogen. For example, one or more thermocouples can be provided proximate the outlets or injection ports for nitrogen within the furnace so as to monitor the temperature of N₂ being discharged near the surface of the load. Further, any one or more suitable pressure sensors (e.g., pressure transducers) and/or flow rate sensors (e.g., flow meters) can be provided at one or more locations within the N₂ distribution lines to monitor and facilitate control of the velocity and/or flow rate of heated N₂ gas within the furnace. Preferably, the pressure of the heated N₂ gas within the distribution lines is low (e.g., at no more than about 3 psig or about 0.2 bar) to ensure the gas is provided to the surface of the load at relatively low discharge velocities.

One or more suitable sensors and related equipment can also be provided to measure and monitor the concentration of the gaseous species within the furnace, preferably at locations in the immediate vicinity of the load surface. One way of monitoring gas concentrations within the furnace globally involves withdrawing gas samples directly from the furnace and/or in the flue gas exhaust duct of the furnace and analyzing the withdrawn gases using one or more suitable analyzers. However, this technique does not provide an accurate indication of the concentration of gaseous species at specific locations within the furnace (e.g., at locations in the immediate vicinity of the load surface).

Another technique which allows for precise measurement of gaseous species and concentrations at specific locations within the furnace is the use of a tunable diode laser system, where a laser beam is directed across the interior of the furnace at a specific location (e.g., very close or proximate the load surface) to measure the average gas composition along the line of travel of the beam. Any suitable tunable diode laser or other method can be utilized such as, e.g., the types described in U.S. Patent Application Publication No. 2003/0132389 and U.S. Pat. No. 7,005,645, the disclosures of which are hereby incorporated by reference in their entireties. Basically, such a system includes a launch module that directs a laser beam across the furnace at a location proximate the load surface, and a receiver module aligned at an opposing location from the launch module to receive the laser signal for processing and determination of concentrations of chemical species based upon a measured intensity of the received laser signal. Utilizing a laser detection system of this type facilitates the determination of local furnace gas compositions very close to the load surface and/or at different points within the furnace. The system can further be used to control the nitrogen injection rate at the load surface based upon such local gas composition measurements.

Thus, the systems and methods described herein facilitate the formation and maintenance of a gaseous atmosphere or layer of at least about 80% by volume of an inert gas such as N₂ at the load surface (e.g., a molten or solid aluminum surface, or a steel slab or billet surface) in a direct-fired heating or melting furnace with a suitably designed injection pipe network or manifold located inside the furnace. Preferably, the systems and methods described herein facilitate the formation and maintenance of a gaseous atmosphere or layer of entirely or substantially 100% by volume of an inert gas such as N₂ at the load surface. This inert gas layer at least partially surrounds the product or load surface and substantially minimizes or prevents contact of the load surface with the global furnace atmosphere which, as noted above, can contain reactive gaseous species (e.g., O₂, CO₂, H₂O, CO, and/or H₂).

When utilizing the inert gas system in a reverberatory aluminum melting furnace, the inert gas pipe manifold or network can be positioned or “hung” directly above the molten bath surface and further configured to be moved or lifted out of the way during processing periods in which the molten bath surface is skimmed. Nitrogen gas can be injected downward and outward to locally inert the aluminum bath surface.

When utilizing a walking beam billet reheat furnace, the inert gas manifold or piping can be positioned below the billet “walking” support mechanism, such that nitrogen and/or other inert gases are injected upward and outward to locally inert the billet surfaces.

The inert gas injection piping can be designed such that the inert gas is first distributed through a heat exchanger that is disposed inside the furnace and/or inside the flue gas exhaust duct or chamber (which facilitates counter-current inert gas heating with the flue gas) prior to being injected at the furnace load surface. In exemplary embodiments, the inert gas heat exchanger is substantially integrated directly upstream from and/or as part of the inert gas manifold or network inside the furnace. Heat exchanger piping for the inert gas can include fins or pins extending transversely external and/or internal to the piping structure and/or any other suitable design configurations that enhance heat transfer efficiencies between the inert gas traveling within the piping and the combustion gases within the furnace or flue gas exhaust chamber. In addition, electrical heating devices can be provided (e.g., external and/or internal to the furnace) to facilitate heating of the inert gas.

Depending upon a particular application, the heat exchanger system can be designed such that inert gas exits the injection ports of the piping manifold or network at a temperature that is the same or substantially similar to the furnace process temperature (e.g., a temperature of at least about 1500° F. (about 815° C.)). By providing the inert gas at or nearly at the furnace process temperature, the load surface will not be cooled to any significant extent by the inert gas. Rather, additional load heating can be provided to the load surface by the inert gas.

The inert gas piping manifold and injection ports are preferably designed to provide a suitable velocity of inert gas injected at the load surface. For example, as noted above, for furnaces utilizing low velocity burners (which provide heating primarily by radiation), nitrogen gas can be injected at relatively low velocity to minimize entrainment and mixing with the furnace atmosphere, while providing sufficient convective heating to the load from the hot N₂ gas impingement. For furnaces utilizing higher velocity burners, with higher levels of furnace gas circulation and impingement on the load, N₂ injection velocity can be increased as desired by suitable manifold and/or injection port designs. The specific volume of the inert gas increases upon being heated, and this allows for a greater number of injection points along the manifold section and a broader and more uniform distribution of inert gas about the load surface.

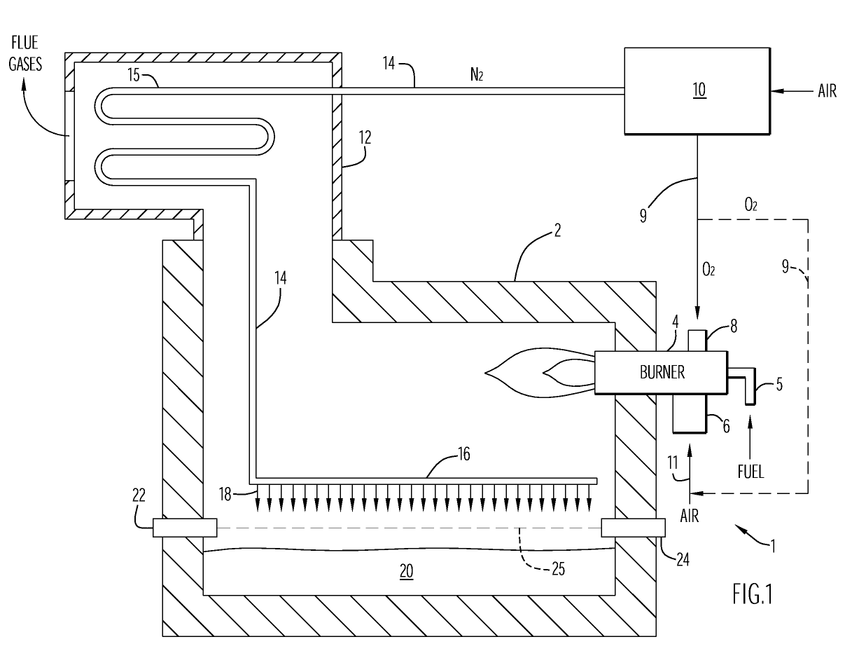

An exemplary embodiment of a direct-fired furnace system utilizing heated nitrogen that provides an inerting layer directly above and that at least partially surrounds the load surface is depicted in FIG. 1. System 1 includes a furnace 2 with a burner 4. The burner 4 includes an inlet port 5 to receive a suitable carbon-based fuel source (e.g., pulverized coal or any other suitable liquid or gaseous hydrocarbons such natural gas, methane, propane, etc.), and at least one inlet (shown as inlets 6 and 8 in FIG. 1) to receive ambient air and/or substantially pure oxygen. The burner generates combustion products which are released into the furnace to create and maintain a heated furnace atmosphere. As can been seen in FIG. 1, burner 4 is designed as a low velocity burner, in which the combustion flame extends above the load and primarily provides radiant heat to the load. However, the burner can also be designed as a high velocity burner, with the combustion flame being aimed to directly impinge the load.

As is shown by the solid and dashed O₂ flow lines 9 in FIG. 1, oxygen can be provided in a separate flow stream and/or combined with an air stream 11 for delivery and entry into the burner. The air and oxygen are provided within the burner at the appropriate ratios with respect to the fuel entering the burner to facilitate a combustion reaction, with combustion products (e.g., N₂, CO, CO₂, H₂O, NOₓ species, hydroxyl species and/or excess or unreacted O₂) emerging from the burner and being directed into the furnace. A flue gas exhaust chamber 12 is provided to vent combustion gases from the furnace system in a conventional manner during operation of the furnace. The flue gases can be further processed to remove pollutants and/or other components from the flue gas stream prior to venting the gas stream to the atmosphere.

Substantially pure oxygen and nitrogen are produced using a single air separation unit (ASU) 10. The ASU 10 receives ambient air and compresses and distills the air in a conventional or any other suitable manner to achieve a separation of at least a substantially purified oxygen stream and a substantially purified nitrogen stream. The oxygen stream is delivered from the ASU 10 to one or more burner inlets 6,8 while the nitrogen stream is directed from the ASU 10 to the flue gas exhaust chamber 12 via a gas pipeline 14.

The nitrogen gas pipeline 14 enters at the outlet of the flue gas exhaust chamber 12 and extends along a looped and winding or serpentine-like path defined by a series of U-shaped bends connecting generally with linear sections of the pipeline within this chamber. The winding or serpentine-like flow path defined by pipeline 14 serves as a heat exchanger section 15 which increases the residence time for the nitrogen flowing within the flue gas exhaust chamber so as to permit sufficient heat exchange between the combustion gases flowing out of the flue gas exhaust chamber and the nitrogen flowing into this chamber. The heat exchanger of system 1 has a counter-current design, where nitrogen flows in heat exchanger section 15 in an opposite direction with respect to the flow of combustion gases through the flue gas exhaust chamber 12. The heat exchanger piping of section 15 (and/or any other piping sections within the furnace) can include any suitable structure (e.g., fins, pins or vanes disposed internal and/or external to the piping) that enhance the heat exchange process so that the nitrogen gas achieves a suitable temperature upon emerging from the pipeline (e.g., the same or substantially similar temperature as the furnace process temperature).

The pipeline 14 extends a suitable distance within furnace 2 toward a load 20 (e.g., molten aluminum or heated steel material) disposed within the furnace. The pipeline includes a manifold or network piping section 16 including a series of outlet or injection ports 18 extending transversely from the main pipeline directly toward the load 20. The pipeline 14 and network piping section 16 are suitably designed and dimensioned so that the nitrogen injection ports 18 are aimed toward and located a close distance from the surface of the load.

The distribution of nitrogen injection ports 18 in piping section 16 is configured such that N₂ gas can be injected to provide a local atmosphere or layer of inerting gas at the surface of the load 20, where the gas composition is primarily nitrogen (e.g., at least about 80% by volume, preferably substantially or nearly 100% by volume) in this local layer. The local inerting layer of nitrogen protects the load surface from the remaining furnace atmosphere of combustion gases.

The injection ports are distributed along the piping section 16 in any suitable manner and can be of any suitable type to facilitate a generally uniform distribution and flow of N₂ gas toward the load surface. For example, the injection ports can be disposed in a grid-like pattern of rows and/or columns or in any other geometric pattern or configuration, where the injection ports are suitably spaced from each other. The injection ports can also be configured as any one or combination of orifices, slots, nozzles, porous or “sintered” filters, screens, packed beds and/or fibrous gas distributors, where the injection ports may be defined as openings along the pipeline sections and/or may extend transversely a selected distance from the pipeline sections in the manifold or network section.

The furnace 2 can include any suitable number and different types of sensors to monitor one or more of the temperature, pressure, flow rate and concentration of nitrogen and/or any other gaseous species within the furnace. For example, a tunable diode laser system can be utilized, with a launch module 22 and a receiver module 24 disposed proximate the load surface to direct a laser beam across the furnace (indicated by dashed line 25 in FIG. 1). The diode laser system facilitates the measurement of the concentration of nitrogen and/or other gaseous species at a location that is proximate the load surface (i.e., at a location between the manifold section 16 and the load surface). The amount of nitrogen provided from the ASU to the furnace, as well as other process parameters (e.g., the amount of oxygen provided from the ASU to the burner), can be selectively adjusted based upon the measured gas species concentration at the load surface.

In operation, air and/or oxygen and a source of fuel are provided to burner 4 to generate a combustion reaction, with the reaction products being delivered into the furnace to heat the load (e.g., a metal such as steel or aluminum). Air separation unit 10 produces a stream of substantially pure oxygen that is delivered to the burner for the combustion reaction. In addition, ASU 10 produces a stream of substantially pure nitrogen that is delivered via pipeline 14 into the flue gas exhaust chamber 12. The nitrogen is heated within the heat exchanger section 15 (and/or within other portions of pipeline 14 within the furnace 2) to a suitable temperature by both radiation and convection as the nitrogen travels toward manifold or network piping section 16. Accordingly, the heated nitrogen is at a suitable temperature prior to emerging from injection ports 18 and being directed toward the surface of load 20. In particular, the N₂ gas temperature is preferably at the same or substantially similar temperature as the furnace process temperature upon emerging from the injection ports 18.

As noted above, typical furnace atmospheres in air/gas fired furnaces, at about 10% excess air, are about 2% by volume O₂, 72% by volume N₂, 9% by volume CO₂, and 17% by volume H₂O (all values at wet basis). The inerting gas system 1 facilitates inerting the load surface with nitrogen to concentrations of at least about 80-90% by volume, preferably about 90-100% by volume, in a local atmosphere or layer proximate the load surface. This in turn significantly reduces or eliminates the local O₂, CO₂ and H₂O concentrations at the load surface and thus significantly reduces or eliminates the occurrence of potential load/atmosphere reactions.

Since portions of the inert gas piping network are disposed within the furnace, the piping network at this location must be of a suitable material to withstand the high furnace temperatures. In particular, the gas piping network is preferably constructed of a suitable steel or steel alloy composition which is configured for use in furnaces below the melting point of steel. Two exemplary processes in which the system of FIG. 1 can be readily implemented are aluminum melting furnaces and steel reheating furnaces.

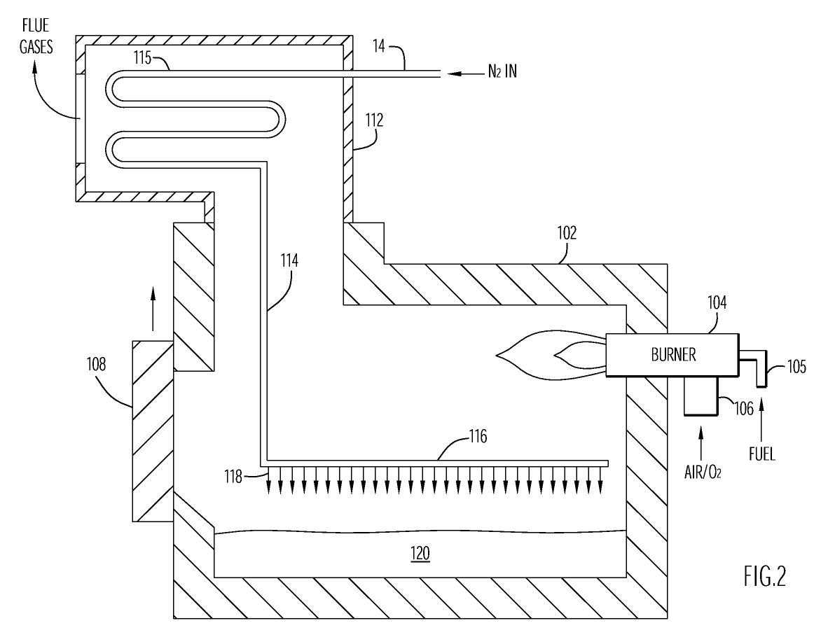

An exemplary embodiment of a reverberatory aluminum melting furnace employing an N₂ inerting gas piping network similar to that described above is depicted in FIG. 2. In particular, furnace 102 includes a burner 104 with inlets 105, 106 that receive fuel and air/oxygen feeds in a similar manner as described above to generate combustion products for delivery to the furnace. The burner can receive air or air enriched with oxygen (e.g., supplied via an ASU in a similar manner as described above). In addition, furnace 102 includes a door 108 that permits the furnace to be opened for periodic skimming of the molten aluminum load 120 within the furnace.

Nitrogen gas pipeline 114 extends in a winding or serpentine manner within the flue gas exhaust chamber 112 of furnace 102 so as to define a heat exchange section 115 within the furnace, where N₂ gas is heated as it flows in a counter-current manner with respect to combustion gases exiting the furnace via the flue gas exhaust chamber. The nitrogen gas can be supplied from an ASU in a similar manner as described above. In addition, the nitrogen gas can be heated using electrical and/or any other heating devices prior to entering the furnace. Preferably, the N₂ gas is heated to be about the same as the aluminum furnace atmospheric temperature (e.g., from about 1600° F. (about 871° C.) to about 2200° F. (about 1204° C.)) prior to being injected toward the molten aluminum surface.

The N₂ gas pipeline 114 extends to a grid or manifold section 116 including a plurality of generally uniformly distributed injection ports. The injection ports can be configured in a similar manner as the embodiment described above so as to facilitate injection of nitrogen in streams 118 toward the molten surface of aluminum load 120. The N₂ manifold section 116 is suspended a suitable distance above the aluminum load surface, preferably about 6 inches (about 15 cm) to about 18 inches (about 46 centimeters). In addition, the manifold section can be configured to be moved away from the load surface when the furnace door 108 is opened, so as to be lifted out of the way during skimming of the load surface. For example, portions of the pipeline 114 and/or manifold section 116 can be constructed of flexible steel hosing with one or more U-bend sections.

The N₂ gas injection ports can be configured to inject nitrogen at a low to medium velocity downward and outward toward the molten aluminum bath so as to provide local inerting and minimize contact of aluminum with the global furnace atmosphere. The local inerting with nitrogen in this manner thus minimizes or prevents the formation of dross at the aluminum surface. The N₂ gas injection ports can further be configured to minimize the entrainment and mixing of N₂ gas combustion gases in the furnace during the injection of nitrogen.

Preferably, the combustion gases are directed at low velocity into the furnace utilizing a “roof hugging” burner to transfer heat primarily by radiation to the aluminum load. The heated N₂ gas can be injected to impinge directly onto the aluminum surface so as to provide convective heat transfer to the aluminum. In addition, the manifold section 116 of the pipeline 114 permits the transfer of radiant heat from the combustion gases to the load surface through open portions between piping of the manifold.

For a typical aluminum melting furnace that is fired with air-fuel burners (e.g., natural gas) at about 11 mM BTU/hr (about 3.2 MW), melting at about 8000 lb/hr (about 3629 kg/hr), total products of combustion are about 125,000 standard cubic feet per hour (SCFH) (about 3540 m³/hr). About 10% of the total product flow, or about 12,000 SCFH (about 340 m³/hr), of N₂ gas should be directed at the bath surface, via the injection ports in the manifold section, to provide suitable inerting at the aluminum load surface (i.e., where a majority, preferably at least 80-90% by volume, of the gas at the load surface is nitrogen). At typical aluminum melting furnace process temperatures, the actual cubic feet per hour (ACFH) of hot N₂ gas is 3 to 5 times this amount, and this gas expansion provides a wider distribution of the nitrogen. To balance this increase in N₂ gas injection with a decrease in burner N₂ supply, a relatively small amount of O₂ enrichment (about 2% by volume) would be required.

The aluminum melting furnace described above can further include any suitable types of sensors, such as the types described above, to enhance process control. For example, the furnace can include a tunable laser diode system to detect location concentrations of nitrogen and/or any other gaseous species proximate the surface of the molten aluminum load within the furnace.

In addition, the aluminum furnace can include any one or more suitable types of bottom-injectors (e.g., in the configuration of porous plugs) to facilitate injection of N₂ and/or other inert gases upward through the molten aluminum bath during operation of the furnace. The injection of inert gases through the molten bath provides a number of benefits to the metal product including stirring, degassing, rinsing, improved metal homogenization, and reduced stratification in addition to assisting local inerting at the molten metal surface.

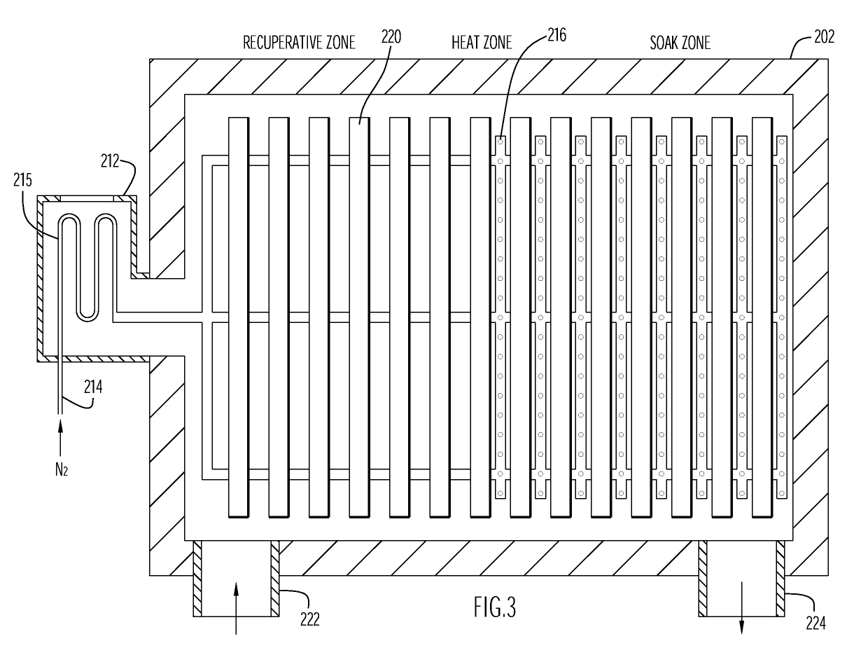

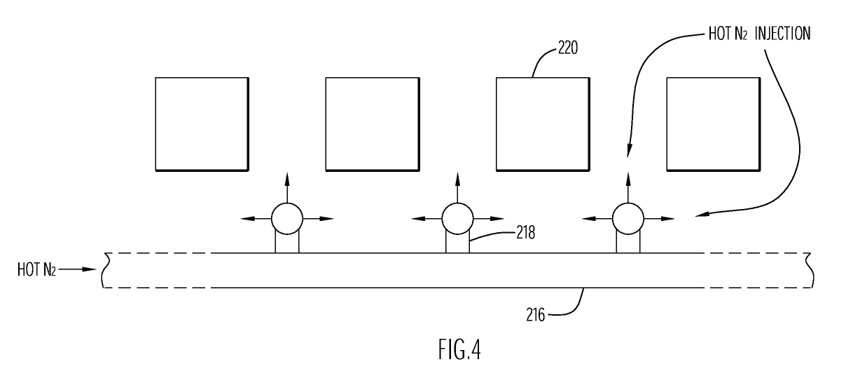

An exemplary embodiment of a walking beam steel reheat furnace employing an N₂ inerting gas piping network similar to those described above is depicted in FIGS. 3 and 4. In particular furnace 202 is similar to the furnaces described above, including a burner (not shown) that receives a fuel with air and/or oxygen to generate combustion products that are provided to the furnace for heating steel billets moving within the furnace. The furnace 202 further includes a flue gas exhaust chamber 212 for venting combustion gases from the furnace.

A N₂ gas pipeline 214 delivers substantially pure nitrogen into the furnace in a manner similar to that described above for providing an inerting layer at the surface of the billets. The pipeline 214 includes a winding or serpentine flow path that defines a heat exchange section 215 for facilitating heat exchange between the nitrogen gas flowing within the pipeline and the combustion gases flowing in a counter-current direction with respect to the nitrogen gas. Preferably, the N₂ gas is heated to be about the same as the steel reheat furnace atmospheric temperature (e.g., from about 1800° F. (about 982° C.) to about 2500° F. (about 1371° C.)) prior to being injected toward the surfaces of the steel billets.

As with the previous embodiments, an ASU can be provided to generate substantially pure N₂ gas and O₂ gas for delivery to pipeline 214 and the burner, respectively. In addition, as in the previous embodiments, any electrical and/or other heating devices can also be employed to heat the N₂ gas to a suitable temperature prior to injection toward the steel billet surfaces within the furnace.

Pipeline 214 extends into furnace 202 and splits into a manifold or grid section 216 to uniformly distribute nitrogen within the furnace at a location proximate the steel billets 220. The grid section 216 is disposed below or beneath a billet walking mechanism (not shown) within the furnace 202. The billet walking mechanism can be a conveyor system or any other suitable support structure that supports the billets and facilitates movement of the billets in a conventional manner through the furnace between a billet inlet 222 and a billet outlet 224 of the furnace. The grid section 216 is located a suitable distance from the billet walking mechanism and billets 220 disposed on the billet walking mechanism, preferably at a distance of about 3 inches or less (about 7.6 cm or less) from the billet walking mechanism.

The furnace includes a recuperative zone disposed at a first section of the furnace including the billet inlet 222, a heat zone disposed at a second central section of the furnace, and a soak zone disposed at a third section of the furnace including the billet outlet 224. Since most scaling and decarburization of steel typically occurs in the heat and soak zones of a steel reheating furnace, the nitrogen inerting of the steel billets can be limited to these two zones in the furnace. Accordingly, the grid section only includes injection ports 218 that release heated nitrogen into the furnace within these two zones. However, in certain applications, nitrogen inerting can be provided throughout the steel reheat furnace (including the recuperative zone).

The grid section 216 includes piping extending in a longitudinal direction of the furnace (i.e., the general direction as the travel path of billets within the furnace) as well as piping extending transverse the longitudinal direction of the furnace, thus forming a connected mesh or grid of piping. The grid section 216 further includes N₂ injection ports 218 disposed in a generally uniform manner along the connected mesh of piping. As can be seen in FIG. 4, the injection ports 218 extend upward from the grid section 216 toward the billets 220 to inject nitrogen in varying directions toward the billet surfaces. The injection ports can be any one or combination of openings, nozzles, filters, porous plugs, etc., which facilitate the flow of nitrogen from the piping into the furnace. Preferably, the furnace and N₂ pipeline grid section are configured such that the injection ports are positioned between billets when the billets are at rest or stationary within the furnace in the heat and soak zones.

As with the previous embodiments, the steel furnace 202 can include any suitable number and types of sensors, including flowrate, pressure, temperature and/or concentration sensors (e.g., a tunable diode laser system) that monitor nitrogen within the furnace so as to control the local composition of nitrogen at the surface of the steel billets.

For a typical steel billet reheat furnace fired with air-fuel burners (natural gas) at about 112 MMBTU/hr (about 33 MW), for about 100 tons per hour (about 90,720 kg/hr) throughput rate, total products of combustion are about 1,300,000 SCFH (about 36,810 m³/hr). For adequate local billet surface inerting, about 10% of this gas flowrate would have to be re-distributed as local N₂ gas injection, or about 130,000 SCFH (about 3,681 m³/hr) of N₂ gas. As noted above, the actual heated N₂ gas volumetric flowrate (ACFH) would be about 3 to 5 times this amount at the furnace process temperatures, and this gas volumetric expansion would help to distribute the N₂ gas over a wider area. The corresponding “balancing” amount of O₂ enrichment would be relatively small (about 2% by volume). As in the previous embodiments, the use of low-velocity radiant burners is preferred in order to allow for the most effective local billet surface N₂ inerting.

The systems and methods described above provide a heated inert gas at the surface of a load within the furnace to effectively minimize or prevent undesirable reactions from occurring between the load surface and combustion gases within the furnace. The systems can be designed using a single ASU that provides suitable amounts of both N₂ and O₂ gases, where the O2 is provided to the burner(s) to enhance or enrich combustion, thus reducing the amount of N₂ supplied to the burners so as to maintain or improve the overall thermal efficiency of the furnace.

Having described novel systems and methods for furnaces utilizing an inert gas to protect products being thermally treated in the furnace, it is believed that other modifications, variations and changes will be suggested to those skilled in the art in view of the teachings set forth herein. It is therefore to be understood that all such variations, modifications and changes are believed to fall within the scope as defined by the appended claims.

1. A heating system comprising:
a furnace configured to receive a product to be thermally treated within the furnace, wherein the furnace includes at least one burner to generate combustion gases from a source of oxygen and a carbon-based fuel source provided to the burner, the combustion gases providing heat to the product disposed within the furnace; and
a gas pipeline that delivers a heated inert gas into the furnace at a location proximate the product so as to at least partially surround and protect a surface of the product and minimize or prevent the product from chemically reacting with other gases within the furnace.

2. The heating system of claim 1, wherein the inert gas is heated to a temperature that is about the same as a temperature of an atmosphere within the furnace prior to release of the gas into the furnace from the pipeline.

3. The heating system of claim 1, wherein the furnace includes a flue gas exhaust chamber to vent combustion gases from the furnace, and a section of the gas pipeline extends through the flue gas exhaust chamber into the furnace.

4. The heating system of claim 3, wherein the section of the gas pipeline extending through the flue gas exhaust chamber comprises a heat exchanger section including a winding flow path defined by U-shaped pipeline portions connected with substantially linear pipeline portions.

5. The heating system of claim 1, wherein the gas pipeline includes a manifold section disposed at a location proximate the product to be thermally treated within the furnace, the manifold section including a plurality of gas injection ports that direct the inert gas toward the product surface.

6. The heating system of claim 5, wherein the manifold section is disposed directly above a location in which the product is thermally treated within the furnace.

7. The heating system of claim 5, wherein the manifold section is disposed directly below a location in which the product is thermally treated within the furnace.

8. The heating system of claim 5, wherein the furnace comprises an aluminum melting furnace, and the manifold section is located within the furnace to be disposed at about 6 inches to about 18 inches from the surface of aluminum product within the furnace.

9. The heating system of claim 8, wherein the manifold section is movable in relation to the surface of aluminum product in the furnace to facilitate skimming of the aluminum product surface.

10. The heating system of claim 5, wherein the furnace comprises a steel reheat furnace, and the manifold section is located within the furnace to be disposed within about 3 inches from the surface of steel product within the furnace.

11. The heating system of claim 1, wherein the inert gas comprises nitrogen.

12. The heating system of claim 11, further comprising:
an air separation unit connected with the pipeline to generate and provide nitrogen to the pipeline for delivery into the furnace.

13. The heating system of claim 12, wherein the air separation unit further generates and provides oxygen to the at least one burner.

14. The heating system of claim 1, further comprising at least one sensor device configured to measure a concentration of at least one gaseous species within the furnace at a location proximate a surface of the product being thermally treated within the furnace.

15. The heating system of claim 1, wherein the gas pipeline is configured to deliver the inert gas toward a surface of the product such that an atmosphere in a region adjacent the product surface comprises the inert gas in an amount from about 80-100% by volume.

16. A method of protecting a product being heated within a furnace, the method comprising:
providing a source of oxygen and a carbon-based fuel source to at least one burner of the furnace to generate combustion gases;
delivering the combustion gases within the furnace to heat the product disposed within the furnace; and
delivering a heated inert gas, via a gas pipeline, into the furnace at a location proximate the product so as to at least partially surround and protect a surface of the product and minimize or prevent the product from chemically reacting with other gases within the furnace.

17. The method of claim 16, wherein the inert gas is heated to a temperature that is about the same as a temperature of an atmosphere within the furnace prior to release of the gas into the furnace from the pipeline.

18. The method of claim 16, further comprising:
venting the combustion gases from the furnace into a flue gas exhaust chamber;
wherein a section of the gas pipeline extends through the flue gas exhaust chamber into the furnace such that the inert gas is at least partially heated within the flue gas exhaust chamber.

19. The method of claim 18, wherein the section of the gas pipeline extending through the flue gas exhaust chamber comprises a heat exchanger section including a winding flow path defined by U-shaped pipeline portions connected with substantially linear pipeline portions.

20. The method of claim 16, wherein the gas pipeline includes a manifold section disposed at a location proximate the product to be thermally treated within the furnace, and the manifold section includes a plurality of gas injection ports that direct the inert gas toward the product surface.

21. The method of claim 16, wherein the manifold section is disposed directly above a location in which the product is thermally treated within the furnace.

22. The method of claim 16, wherein the manifold section is disposed directly below a location in which the product is thermally treated within the furnace.

23. The method of claim 16, wherein the product comprises molten aluminum, and the manifold section is located within the furnace at about 6 inches to about 18 inches from the surface of the molten aluminum within the furnace.

24. The method of claim 16, wherein the product comprises steel, and the manifold section is located within about 3 inches from the surface of the steel within the furnace.

25. The method of claim 16, wherein the inert gas comprises nitrogen.

26. The method of claim 25, further comprising:
processing air in an air separation unit to generate a stream of nitrogen; and
delivering the stream of nitrogen to the pipeline and into the furnace.

27. The method of claim 26, further comprising:
further processing air in the air separation unit to generate a stream of oxygen; and
delivering the stream of oxygen to the at least one burner.

28. The method of claim 16, further comprising:
measuring a concentration of at least one gaseous species, via at least one sensor, within the furnace at a location proximate a surface of the product disposed within the furnace.

29. The method of claim 16, wherein the inert gas is delivered by the gas pipeline toward a surface of the product such that an atmosphere in a region adjacent the product surface comprises the inert gas in an amount from about 80-100% by volume.

30. A heating system comprising:
a furnace configured to receive and thermally treat a product within the furnace; and
a means for delivering a heated inert gas into the furnace at a location proximate the product so as to at least partially surround and protect a surface of the product and minimize or prevent the product from chemically reacting with other gases within the furnace.
